(19) United States
(12) Patent Application Publication
(10) Pub. No.: US 2007/0237933 A1
(43) Pub. Date: Oct. 11, 2007

(54) Method of embossing a coated sheet with a diffraction or holographic pattern and coated sheet therefor

(76) Inventor: Brian R. Mentz, Franklin, MA (US)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 11/400,012

(22) Filed: Apr. 8, 2006

(51) Int. Cl. B32B 3/00

(52) U.S. Cl. 428/206; 427/271; 156/209; 359/1; 428/211.1

(57) ABSTRACT

A coated sheet comprising a substrate, a coating and a surface embossing. The substrate includes a top surface and a bottom surface. The coating is applied to at least one of the top surface and the bottom surface. The coating includes an IR absorbing material dispersed within the coating. The surface embossing is disposed within the coating. A method of embossing such a coated sheet is likewise disclosed.

### BACKGROUND OF THE INVENTION

1. Field of the Invention

The invention relates in general to decorative sheeting, and more particularly to a method of embossing a coated sheet with a diffraction or holographic pattern, and the coated sheet used in association therewith.

2. Background Art

The embossing of coated sheets, and the optional application of a metalized layer thereto is well known in the art. One such example is disclosed in U.S. Pat. Nos. 4,913,858, 5,164,227 and 5,155,604 all issued to Miekka et al, the entirety of each of which is hereby incorporated by reference herein in their respective entirety. These references disclose the coating of a substrate with a polymer, and the subsequent embossing of same through a process, to provide a diffraction pattern or hologram. While such processes have been adopted and utilized with success, there have been drawbacks to the processes disclosed.

Among other deficiencies, manner in which the substrate and coating is heated leads to certain degradation of the substrate and embossing equipment. In particular, while it is necessary to heat the coating to a softened condition, an undesirable byproduct is that the substrate likewise becomes heated. Due to the nature of the heating and the manner in which heating has been applied to both elements, the substrate becomes degraded. Indeed, the usable substrates are often limited. For example, due to the elevated temperatures, the substrate may exhibit excessive curling and may require extensive trimming (which leads to substantial waste). Additionally, the elevated temperatures of the substrate negatively impacts the equipment necessary to carry out the embossing process. For example, the rubber rollers may exhibit a baking effect, or may include localized areas of increased hardness. Likewise, the embossing rollers exhibit a shortened usable life and require replacement with increased frequency.

In addition to the damaging effects on the equipment and the substrate, the manner in which the heating is carried out requires the extensive expenditure of energy as the substrate is unnecessarily heated. Subsequently, the drying time of the coating is increased until the heat in the substrate is dissipated. Thus, the speed at which the method can be operated is negatively impacted by the extended drying and cooling time.

Accordingly, it is an object of the invention to provide an IR absorbing material dispersed within the coating to increase the absorption of heat by the coating.

It is another object of the invention to increase the temperature gradient across the coating and substrate.

It is another object of the invention to minimize and reduce the damage to the substrate due to the embossing process.

It is another object of the invention to increase the life of embossing equipment.

It is another object of the invention to minimize the energy required to impart an embossing to the coating on the substrate.

It is another object of the invention to increase the speed at which the embossing can be accomplished through reduced drying times for the coating.

These objects as well as other objects of the present invention will become apparent in light of the present specification, claims, and drawings.

### SUMMARY OF THE INVENTION

The invention comprises, in one aspect, a coated sheet comprising a substrate, a coating and a surface embossing. The substrate includes a top surface and a bottom surface. The coating is applied to at least one of the top surface and the bottom surface. The coating includes an IR absorbing material dispersed within the coating. The surface embossing is disposed within the coating.

In a preferred embodiment, the coating has a thickness which is greater than the surface roughness of the at least one surface.

In another preferred embodiment, the substrate comprises a paperboard material.

In a preferred embodiment, the IR absorbing material comprises carbon black. In one such embodiment, the amount of carbon black dispersed into the coating comprises between about 2.5% and 7.5%.

In another embodiment, the IR absorbing material comprises nigrosine dye. In one such embodiment, the amount of nigrosine dye comprises between about 1.0% and 5.0%.

In another preferred embodiment, the IR absorbing material is selected from the group consisting of carbon black, nigrosine dye, and optically transparent IR dyes, such as Amaplast® IR 1000, available from Color Chem International Corp.

In another aspect of the invention, the invention comprises a method of embossing a sheet of material comprising the steps of: providing a substrate; coating the substrate with a coating having an IR absorbing material dispersed therein; heating the coating through an IR heater; and embossing the coating with a pattern.

In a preferred embodiment, the method further comprises the step of minimizing the convective heating of the substrate by the IR heater.

In a preferred embodiment, the method further comprises the step of minimizing the conductive heating of the substrate by the IR heater.

In another preferred embodiment, the steps of heating and embossing results in a coating that has a microstructure embossing transfer efficiency greater than that of a conventional coating undergoing the same steps of heating and embossing.

In another preferred embodiment, the step of heating elevates the temperature of the coating having the IR absorbing material to a temperature higher than a similar coating not having the IR absorbing material dispersed therein.

In yet another preferred embodiment, the method further comprises the steps of applying a metalized layer over the embossed coating.

### BRIEF DESCRIPTION OF THE DRAWINGS

The invention will now be described with reference to the drawings wherein:

FIG. 1 of the drawings comprises a cross-sectional view of a portion of the coated sheet prior to the step of embossing;

FIG. 2 of the drawings comprises a cross-sectional view of a portion of the coated sheet after step of embossing;

FIG. 3 of the drawings comprises a schematic representation of the step of applying the coating to the substrate;

FIG. 4 of the drawings comprises a schematic representation of the step of heating and/or softening the coating with IR heaters;

FIG. 5 of the drawings comprises a schematic representation of the step of heating and/or softening the coating with IR heaters, while minimizing the heating of the underlying substrate through convection; and

FIG. 6 of the drawings comprises a schematic representation of the step of embossing of the coated sheet, and applying a metalized layer to the embossed coated sheet.

### DETAILED DESCRIPTION OF THE DRAWINGS

While this invention is susceptible of embodiment in many different forms, there is shown in the drawings and described herein in detail a specific embodiment with the understanding that the present disclosure is to be considered as an exemplification of the principles of the invention and is not intended to limit the invention to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

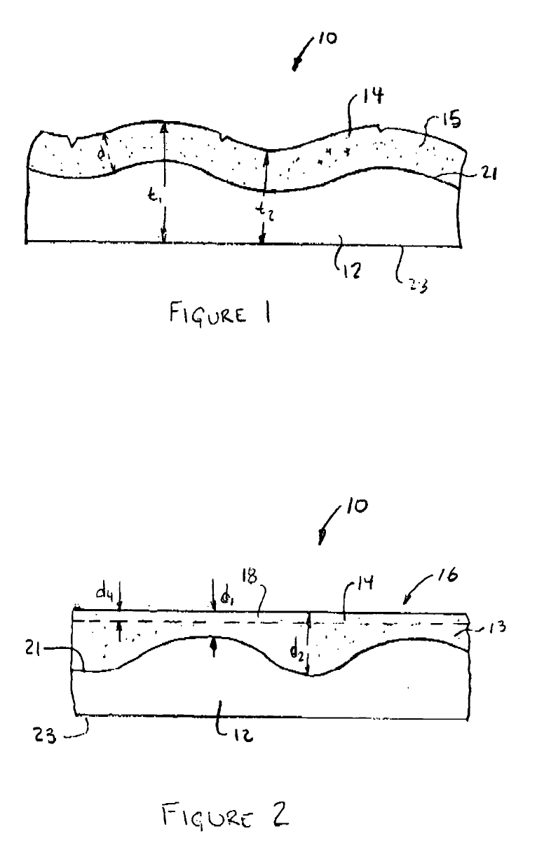

Referring now to the drawings and in particular to FIGS. 1 and/or 2, a cross-sectional configuration of the coated sheet 10 is shown. The coated sheet 10 includes substrate 12, at least one coating, such as coating 14, and optionally, metalized layer 16. Substrate 12 include top surface 21 and bottom surface 23. Substrate thickness usually varies from about 40 microns to about 100 microns. Of course, thicknesses outside of this range are contemplated for use as well, such as, for example, cardboard stock having a thickness up to about 750 microns. Furthermore, the invention is not limited to paperboard of any particular type or class, i.e., recycled, virgin, post-consumer or pre-consumer. In another embodiment, the substrate may comprise a polymer-based material or film. Examples of such films comprise low density polyethylene (LDPE), high density polyethylene (HDPE), polypropylene (PP), polyvinyl chloride (PVC), polyethylene terephthalate (PET), polyvinylidine chloride (PVDC), polychlorotrifluoroethylene (PCTFE), polyvinyl alcohol (PVOH), ethylene-vinyl alcohol (EVOH), polyamide (Nylon), and ethylene-vinyl acetate (EVA), among others. Generally the substrate is provided as web of material wound into a roll. Typically, such rolls may have a width of approximately 3 to 15 feet, and may include lengths of 5,000 to 100,000 feet of material. Of course, smaller rolls are likewise contemplated.

Coating 14 is shown in FIG. 1 as comprising a single layer coating, while multiple layers of coating are contemplated. The coating 14 is shown as being applied to top surface 21, while application thereof to bottom surface 23 or to both surfaces is contemplated. Typically, the coating comprises a thermoplastic material such as polyethylene, polystyrene, polyvinyl chloride and styrene butadiene-like thermoplastics or semicured thermosets (“B” staged) which have discernable thermoplastic properties. One such coating comprises an acrylic-based polymer such as is available from Dianal America, Inc. Other coatings comprise homopolymers and copolymers of acrylic, styrenated acrylics or acrylated styrenes such as are available from Eliokem, Dianal America, Inc., or Lucite International. Structurally, coating 14 comprises a thickness advantageously between about 1.5 microns to about 50 microns, or greater. Most preferably, coating 14 comprises a thickness of between about 4 to 10 microns. This corresponds to a coating basis weight, e.g., of polyethylene, of between about 2 to 6 lbs. per 3,000 sq. ft. of coating applied.

Coating 14 includes an IR absorbing member 15 dispersed within the polymer matrix. Among other contemplated embodiments, carbon black IR absorber is included in the coating 14. The carbon black member may be between about 2% and about 10% solids content. Other IR absorbing materials are contemplated for use, such as, nigrosine dye at, preferably, a similar solids content as the carbon black member.

As will be explained below, coating 14 is imprinted with an embossing roller so as to impart an embossed surface configuration to the underlying coating. It will be understood that substrate 12 has a surface roughness which defines a variable thickness ranging between a maximum thickness t₁, and a minimum thickness t₂. The coating has a uniform depth d₁. With reference to FIG. 2, the thickness, t₃, is nearly uniform, but the coating depth now varies from d₂ to d₃ due to the calendaring effect. The embossing pattern depth d₄ is less than the original surface roughness (t₁-t₂).

In the presently shown embodiment, and in many typical embodiments, the surface roughness of substrate 12 (i.e., the average peak-to-valley surface height variation), varies from about 1.0 to about 3.0 microns. Of course, rougher or smoother substrates 12 may also be used. For example, substrates having surface peak-to-valley roughness of up to 5.0 microns, or even higher may also be used.

With reference to FIGS. 1 and 2, after coating 14 is applied, but before embossing, the surface roughness (t₁-t₂) will typically be somewhat lower than the surface roughness of substrate 12 alone. It has been determined that the surface roughness (t₁-t₂), after coating 14 has been applied, may typically be about 70 to 90 percent of the original base paper roughness. After embossing, the embossing depth illustrated schematically in FIG. 2 is less than the original coated-surface roughness (t₁-t₂). The embossing pattern depth d₄ will be less than 1.0 micron and may vary typically from about 0.1 micron to about 0.5 micron more usually between about 0.2 to about 0.4 micron. Of course, other dimensions may be realized within the scope of the present invention.

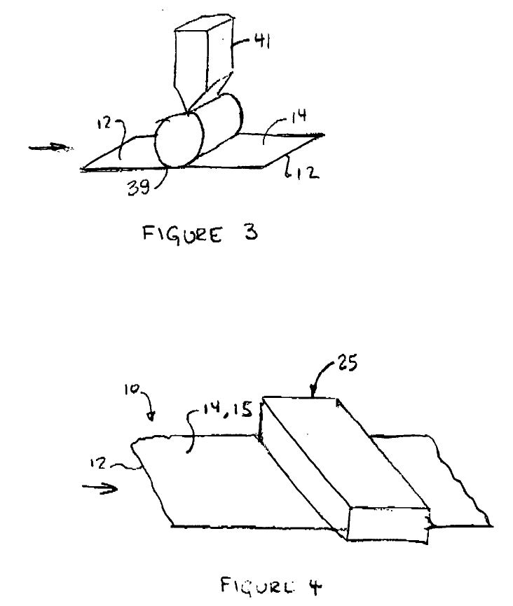

To form the coated sheet, it is necessary to first apply coating 14 upon substrate 12. In certain embodiments, coating 14 may be applied through extrusion. In other embodiments, as is shown in FIG. 3, the coating may be applied from a holding member 41 through the application of the coating upon a heated roller 39 for transfer onto the substrate. In still other embodiments, the coating may be sprayed or otherwise deposited upon the substrate. A number of different manners of applying the coating to the substrate are contemplated within the scope of the present invention. It is contemplated that the IR absorber can be added to the coating during preparation of the coating for application onto the substrate.

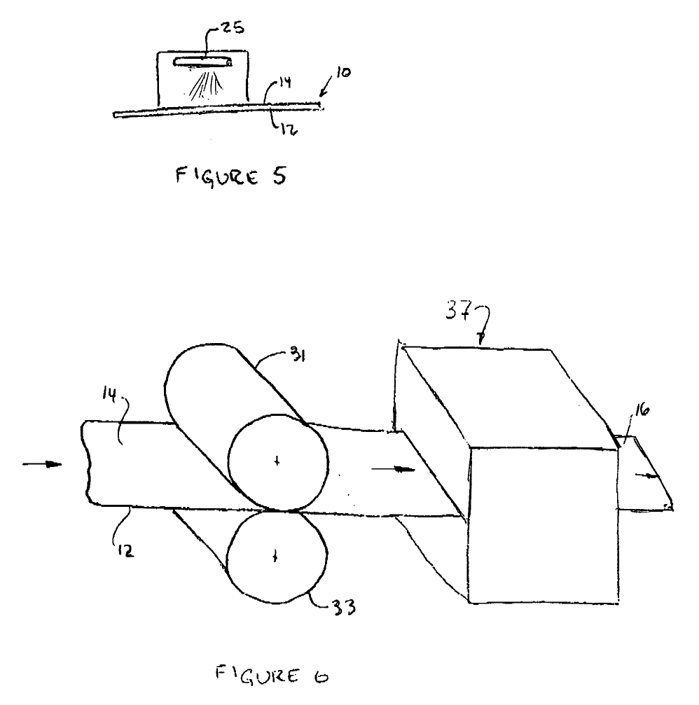

Once the substrate has been coated with coating 14 to the appropriate thickness, it is necessary to heat the coating to a temperature which allows for embossing. With the method of the present embodiment, the use of ovens is minimized, and IR heaters, such as IR heater 25 shown in FIGS. 4 and 5, are employed. The IR heaters are positioned so as to direct IR energy to the coating, while minimizing direct and indirect contact with the substrate. As such, the IR heaters are directed to the coated surface of the coated sheet. It is preferred to maintain the side opposite of the IR heaters open or otherwise free from substantial enclosure so as to preclude convective heating of the substrate by the IR heaters.

Due to the direction of IR heaters upon the coating 14 which includes the IR absorber dispersed therewithin, the temperature of the coating increases while minimizing heat imparted (i.e., conducted) to the underlying substrate. Furthermore, the inclusion of an IR absorber minimizes the exposure time of the substrate and coating to the IR heaters. Still further, while for some applications, an oven, such as a gas oven may be necessary as a supplement, ovens may be eliminated from certain applications. Furthermore, even where such ovens are required, the exposure to same can be minimized.

Once the coating of the coated sheet exits the IR heaters, it is at an elevated temperature and therefore softened state wherein it can be processed by the embossing rollers. Specifically, once coating 14 has been softened, an embossing arrangement is employed for decoration. As is shown in FIG. 6, the arrangement comprises an embossing roll 31 and a pressure nip roll 33. The embossing roller 31 is a conventional embossing master which has the desired embossing pattern. This pattern is produced on the roller or rollers by engraving, embossing with a hard material, mounting patterned plastic films or metal films onto the surface of the roller, or through other means. When the embossing roller 31 contacts the softened coating 14, it transfers an embossment pattern to the coating 14 on the paper and simultaneously cools the coating so that it will not flow after being removed from the embossing roller. Thus, in the case of polyethylene, an embossed pattern becomes embedded in the polyethylene surface. The result is decorated, polycoated paper.

The temperature of the embossing master (embossing roller 31) is preferably below the effective softening temperature of coating 14. The temperature of embossing roller 31, however, should not be so low as to harden coating 14 before the embossing is completed. It has been found that the preferred temperature for embossing roller 31 (embossing master) can vary depending on its thermal conductivity and specific heat, the embossing nip pressure, operating speed and the temperature to which coating 14 is heated immediately prior to contact with the embossing roller 31. Despite the large number of variables, applicant has determined that the embossing master (roller 31) preferred temperature in the process of the present invention is between about 20° F. to about 60° F. below the self-adhesive temperature of the coating 14. The self-adhesive temperature of the coating 14 is defined as the minimum temperature at which two layers of the coating (excluding any release agents added to the coating) will mutually adhere when pressed together. It has been determined that, in the context of the present process, this generally places the preferred embossing master (embossing roller 31) temperature between about 120° F. and 220° F. Of course, the invention is not limited to such temperature ranges, and can vary with different substrate and coating materials.

Once embossed, the coated sheet may be transmitted through another process which applies a metalized coating 16 to the embossed coated sheet in device 37 (FIG. 6). In certain embodiments, such a process may be carried out through the use of vapor deposition or vacuum deposition of metalized particles upon the surface of the coated sheet. Further steps and coatings may be applied to the outer surface of the metalized coating so as to protect the metallic particles, or to otherwise produce enhanced features to the underlying coated sheet.

A number of experiments were conducted comparing the coated sheet of the present invention with the conventional coated sheets. In particular, two different formulations of acrylate-based polymer coatings were provided. Each such coating was provided on Dunn 605/300 base paper. The first formulation included carbon black IR absorber at 3.3% solids. The second formulation did not include any IR absorber within the acrylate-based polymer coating.

Both of the sheets were processed at 400 FPM through an embosser utilizing IR heating. The coated surface temperature of the coated sheet made in accordance with the present invention was approximately 412° F. The coated surface temperature of the conventional coated sheet was approximately 372° F. Not only was the temperature of the web increased with the use of the coated sheet of the present invention, but the quality of the embossing increased. In particular, the embossing transfer efficiency for the coated sheet of the present invention was approximately 2.6, whereas the embossing transfer efficiency of the conventional sheet was approximately 1.1. The embossing transfer efficiency scale is derived from a function that assigns a 1-to-10-scale in accordance with the effective area transferred from the master to the web surfaces. A zero would indicate no transfer and a ten would indicate complete transfer.

By relying on IR heaters, instead of gas ovens, the underlying substrate can remain cooler, while heating the coating to a desired temperature. Thus, a comparatively large temperature gradient can be created across the coated sheet. Furthermore, the time in which the substrate is exposed to heating can be minimized, thereby minimizing degradation to the substrate such as dehydration and fiber deformation. Moreover, cooling time can be reduced. The coated sheet also exhibits less curling and less trimming of waste. Furthermore the embossing cylinder and the pressing rubber nip roller exhibit longer life. Specifically, the embossing cylinder exhibits longer shim life and has less polymer transfer to the shim.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A coated sheet comprising:
a substrate having a top surface and a bottom surface;
a coating applied to at least one of the top surface and the bottom surface, the coating including an IR absorbing material dispersed within the coating;
a surface embossing disposed within the coating.

2. The coated sheet of claim 1 wherein the coating has a thickness which is greater than the surface roughness of the at least one surface.

3. The coated sheet of claim 1 wherein the substrate comprises a paperboard material.

4. The coated sheet of claim 1 wherein the IR absorbing material comprises carbon black.

5. The coated sheet of claim 4 wherein the amount of carbon black dispersed into the coating comprises between about 2.5% and 7.5%.

6. The coated sheet of claim 1 wherein the IR absorbing material comprises nigrosine dye.

7. The coated sheet of claim 6 wherein the amount of nigrosine dye comprises between about 1.0% and 5.0%.

8. The coated sheet of claim 1 wherein the IR absorbing material is selected from the group consisting of carbon black, nigrosine dye, and optically transparent IR dyes.

9. The method of embossing a sheet of material comprising the steps of:
providing a substrate;
coating the substrate with a coating having a IR absorbing material dispersed therein;
heating the coating through an IR heater; and
embossing the coating with a pattern.

10. The method of embossing of claim 9 further comprising the step of minimizing the convective heating of the substrate by the IR heater.

11. The method of embossing of claim 9 further comprising the step of minimizing the conductive heating of the substrate by the IR heater.

12. The method of embossing of claim 9 wherein the steps of heating and embossing results in a coating that has a transfer efficiency greater than that of a conventional coating undergoing the same steps of heating and embossing.

13. The method of embossing of claim 9 wherein the step of heating elevates the temperature of the coating having the IR absorbing material to a temperature higher than a similar coating not having the IR absorbing material dispersed therein.

14. The method of embossing of claim 9 further comprising the steps of applying a metalized layer over the embossed coating.
